(19) United States
(12) Patent Application Publication
(10) Pub. No.: US 2009/0198856 A1
(43) Pub. Date: Aug. 6, 2009

(54) GATEWAY FOR A DATA BUS SYSTEM

(75) Inventor: Hartmut Habben, Hamburg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/301,419

(22) PCT Filed: May 16, 2007
(86) PCT No.: PCT/IB07/51868

§ 371 Date: Nov. 18, 2008

(30) Foreign Application Priority Data
May 18, 2006 (EP) 06114147.9

(51) Int. Cl. G06F 13/14

(52) U.S. Cl. 710/305

(57) ABSTRACT

The invention is related to a Gateway for a data bus system, especially a CAN-Bus-system, with at least two data bus source channels, the gateway being provided with—an interface for each data bus source channel, —a protocol core in each channel interface, —a channel message switch, whose inputs are coupled to the outputs of the protocol cores of the channel interfaces and whose output can be switched to one of its inputs, —a message handler coupled to the output of the channel message switch and being provided with a message filter for selecting messages and with a message buffer, —a channel interface with a protocol core coupled to a data bus target channel, —a control, that, in a diagnostic copy function, copies all the messages from a selectable source channel to the message handler by setting the channel message switch to the position assigned to the selected source channel and that causes the message filter to couple the filtered messages to the interface of the target channel.

The invention relates to a gateway for a data bus system. The gateway is provided with interfaces for at least two source channels and at least one target channel as well as with a copy function for diagnostic purposes in multi channel networks.

Especially in multi channel networks there is a need to monitor network traffic of certain channels for diagnostic purposes. During these diagnostic phases the network traffic from a source channel is made available on a diagnostic or target channel.

Some current realisations simply assign this task to the host processor of a gateway as a software task. Although this realisation is easy to implement because no extra hardware is required, the disadvantage is that the gateway suffers a real time infringement during the diagnosis mode. As a consequence, no guaranteed latency times for the monitored messages can be given anymore. An even more severe limitation is, that only received messages by the gateway are transferred to the diagnosis bus. Other rejected messages remain invisible to the diagnosis bus.

Other multi channel systems are using an extra, so-called monitor device comprising a complete receive-logic connecting the monitor by a channel switch to the source channel. The disadvantage here is the additional receive logic, which is used twice in the source channels as well as in the monitor channel. Furthermore special caution has to taken in synchronising the source channel and the monitor channel to each other.

Old multi channel systems were bypassing this problem by simply using relays to connect the diagnosis channel to the selected source channel during the diagnosis mode. Although the system in this approach has no real time infringements per se, it is linked to quite high costs. Each source channel that is to be monitored requires connecting an external relay with additional control circuits and so more wire harness becomes necessary.

From WO 2005/015850A1 a device for diagnosis in Multi-Channel-CAN-Applications is known, in which one of the interfaces is a selector interface, which is connected with a switch, that can be switched to one of the source channels. This allows copying of one the data channels to the selector interface which has two protocol cores, one for receiving the messages from the source channel, to which the switch is switched, and one for copying the decoded and then encoded messages to a target channel. This solution has two main drawbacks: The selector interface has two protocol cores, which need chip space. The second drawback is that the source channel, to which the selector interface is coupled, is coupled to two receiving interfaces, the one to which it is coupled for “normal data traffic” and to the selector interface. If both interfaces do not work exactly synchronously, which may easily happen, the handshakes on the source channel will go wrong, hence disturbing the data traffic on the channel.

It is therefore an object of the present invention to indicate a gateway that offers a diagnostic function as explained above that works without any possible disturbance of the data traffic and that is simple and cheap to implement.

This object is solved by the solution according to claim 1:

Gateway for a data bus system, especially a CAN-Bus-system, with at least two data bus source channels, the gateway being provided with
an interface for each data bus source channel,
a protocol core in each channel interface,
a channel message switch, whose inputs are coupled to the outputs of the protocol cores of the channel interfaces and whose output can be switched to one of its inputs,
a message handler coupled to the output of the channel message switch and being provided with a message filter for selecting messages and with a message buffer,
a channel interface with a protocol core coupled to a data bus target channel,
a control, that, in a diagnostic copy function,
   copies all the messages from a selectable source channel to the message handler by setting the channel message switch to the position assigned to the selected source channel and that
   causes the message filter to couple the filtered messages to the interface of the target channel.

The gateway according to the invention offers a hardware implemented copy function for diagnostic purposes, which has no influence on the data traffic on the source channels, especially not on the source channel, which is selected for copying. Hence, the “normal” gateway application suffers no real time infringement during the diagnosis mode. There is no drain on the central processing unit (CPU) with enabled diagnostic copy function. The Source channel of the diagnostic copy function is freely assignable to any of the available CAN channels.

In contrast to the solution according to WO 2005/015850A1, the gateway uses a switch for the diagnostic copy function that is coupled to the outputs of the protocol cores of the interfaces assigned to the source channels and thus copies already decoded messages, whereas the solution according to the WO-document switches the bus lines themselves with the disadvantages described above.

The gateway doesn't need a special interface with two protocol cores but uses the “normal” interfaces, that are also used for the normal application.

The gateway additionally offers a hardware implemented filter function to exclude or to include certain identifier scopes from the diagnostic copy function (Acceptance filtering for diagnostic copy function).

Further advantageous embodiments are indicated in the claims 2 and 3. The gateway according to claim 2 allows an additional selection of a target channel, to which messages are copied in the diagnostic copy function.

The invention is described below in detail with reference to the accompanying schematic drawings, wherein

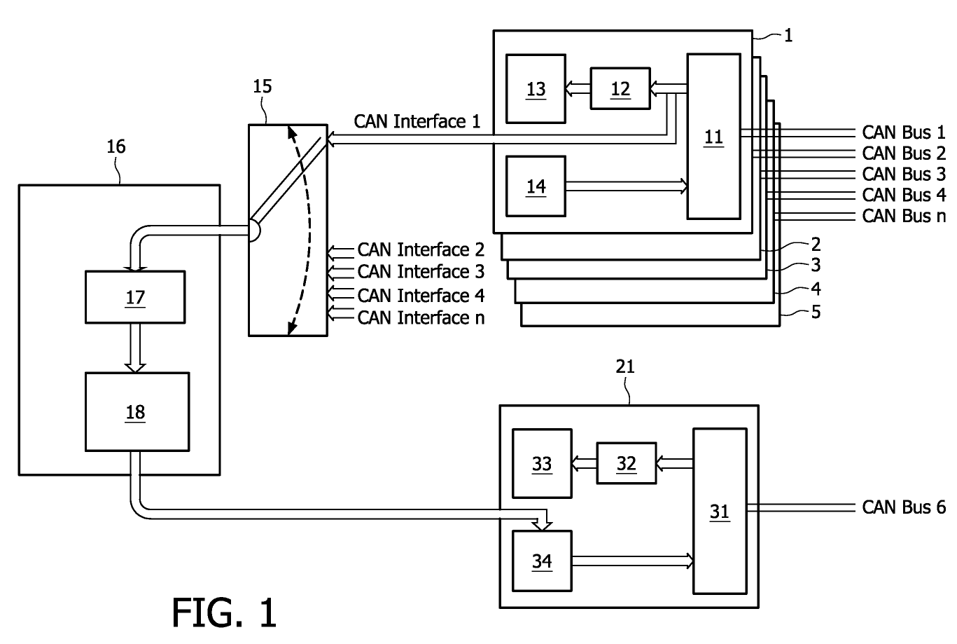

FIG. 1 shows a gateway according to the invention with a channel message switch for a diagnostic copy function;

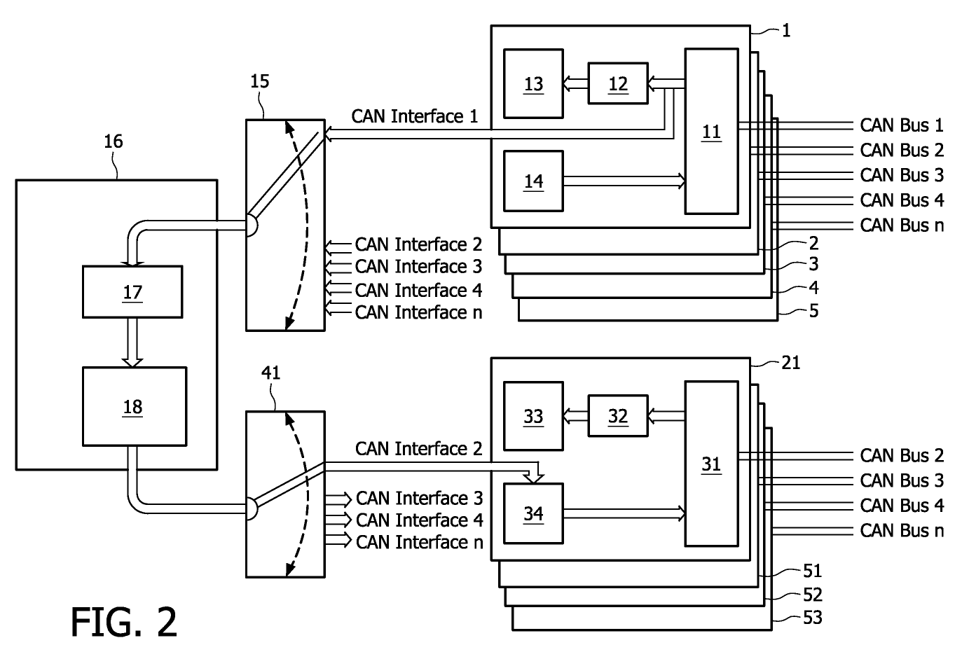

FIG. 2 shows the gateway according to FIG. 1 with an additional second message switch for selecting the target channel.

FIG. 1 shows a gateway according to the invention, that is designed for a CAN-bus-system according to the CAN standard. However, its main elements and especially its diagnostic copy function could also be used in gateways designed for other bus systems. The gateway is provided with source interfaces 1 to 5 which are coupled to CAN-busses 1 to n. The “n” indicates that the number of interfaces and CAN busses is of course not limited to five. Each of the interfaces 1 to 5 is coupled to one of the CAN busses. In relation to a diagnostic copy function, which will be described in detail below, the five channels are referred to as source channels.

In the FIG. 1, the interface 1, which coupled to the CAN bus 1, is depicted in more detail. It is supplied with a protocol handler 11, which mainly does the encoding of messages to be sent on the CAN bus 1 and the decoding of messages received from this bus. Furthermore it is provided with a message filter 12 for message filtering, a receive buffer 13 for storing received messages and a transmit buffer 14 for storing messages to be sent. The elements 12, 13 and 14 of the interface 1 are only used in the “normal” function of the gateway for sending and receiving messages and are not explained in more detail as they are not relevant for the diagnostic copy function.

The gateway according to FIG. 1 has a channel message switch 15 that has several inputs coupled to CAN interface 1 to CAN interface n. Each of these inputs is coupled to the output of one of the protocol cores of the CAN interfaces 1 to 5.

The switch 15 has one output that is coupled to a message handler 16, which is provided with a message filter 17 and a message buffer 18.

The message filter 17, which is not mandatory, consists a filter function to exclude or to include certain identifier scopes from the diagnostic copy function to be described below. The Message Buffer FIFO 18 is used for temporarily message storage to cover worst-case scenarios, when for example long messages on the source channel are received and followed by short messages. The message handler 16 moves accepted messages by the message filter 17 to a transmit buffer of the target/diagnostic channel.

The output of the message handler 16 is coupled to a transmit buffer 34 in a target channel interface 21, that is coupled to a target CAN bus t. The interface has a protocol core 31, a message filter 32 and a receive buffer 33, which offer the same functions as the elements 11, 12 and 13 in the source channel interface 1.

The main inventive element of the gateway is a so called diagnostic copy function which allows copying of messages of one of the source channels CAN bus 1 to CAN bus n to the target channel CAN bus t, which may be identical with one of the source channels 1 to n.

This is mainly achieved with the Source CAN Channel Message Switch 15, which allows to select one channel of the available source channels from which the received messages are taken for the diagnostic copy function. For this, the channel message switch 15 is put into the according position by a control not shown in the Figure.

Lets assume the switch 15 has been switched to its first position, in which its first input is active, which is coupled to the protocol core 11 of interface 1. Then all the messages, which the interface 1 receives from CAN bus 1, are decoded by its protocol handler 11 and are coupled to the switch 15, which couples them to the message handler 16, which may filter the messages as described above. The remaining messages are coupled to the transmit buffer 34 of the target channel interface 31 and are encoded by the protocol handler 31 and transmitted on the target CAN-bus t. Thus, the messages are copied from the source channel to the target channel. Depending on the position of the message switch 15 this copying can be done from any of the source channels CAN bus 1 to n to the target channel CAN bus t.

This procedure takes place when the diagnostic copy function is activated. Then each interface 1 to 5 of the source channels is using a so-called self-reception mode. In the self-reception mode each message which was set-up by the application as a transmit message, is not only transmitted but also received in the source channel and therefore also made available for diagnostic copy function.

FIG. 2 shows a further embodiment of the gateway according to the invention which is provided with all the elements of the gateway according to FIG. 1 and which is additionally provided with a target channel message switch 41 and with not only one target channel but with several target channels 2 to n. In this embodiment the diagnostic copy function is able to copy messages from one of the source channels to a selectable target channel. For this, the target message channel switch is used to couple the output of the message handler 16 to one of the interfaces 21, 51, 52 or 53. Hence, not only the source channel but also the target channel can be selected.

1. Gateway for a data bus system, especially a Controller-Area Network (CAN)-Bus-system, with at least two data bus source channels, the gateway being provided with
an interface for each data bus source channel,
a protocol core in each channel interface, a channel message switch, whose inputs are coupled to the outputs of the protocol cores of the channel interfaces and whose output can be switched to one of its inputs,
a message handler coupled to the output of the channel message switch and being provided with a message filter for selecting messages and with a message buffer,
a channel interface with a protocol core coupled to a data bus target channel,
a control, that, in a diagnostic copy function,
copies all the messages from a selectable source channel to the message handler by setting the channel message switch to the position assigned to the selected source channel and that
causes the message filter to couple the filtered messages to the interface of the target channel.

2. Gateway according to claim 2, characterized in that the gateway is provided with a second message switch, which is designed to switch the messages, that are output by the message handler, to one of more than one target channel interface.

3. Gateway accordingly to claim 1, characterized in that the data bus is a bus according to the CAN standard.
